(19) United States
(12) Patent Application Publication
(10) Pub. No.: US 2020/0405570 A1
(43) Pub. Date: Dec. 31, 2020

(54) Chair-Type Massage Machine

(71) Applicant: Fuji Medical Instruments Mfg. Co., Ltd., Osaka (JP)

(72) Inventor: Shogo KODAMA, Osaka (JP)

(73) Assignee: Fuji Medical Instruments Mfg. Co., Ltd., Osaka (JP)

(21) Appl. No.: 16/801,289

(22) Filed: Feb. 26, 2020

(30) Foreign Application Priority Data
Jun. 28, 2019 (JP) 2019-121105

(51) Int. Cl. A61H 9/00

(52) U.S. Cl. CPC A61H 9/0078; A61H 2201/1638; A61H 2205/06; A61H 2201/1409; A61H 2201/0149

(57) ABSTRACT

Provided is a chair-type massage machine including an arm treatment portion. The arm treatment portion includes an arm insertion groove part that is open at an upper part thereof and an expansion/contraction part that is disposed in the arm insertion groove part and expands and contracts. The arm insertion groove part includes a placement surface, a pair of inner side surfaces that are disposed on an upper side of the placement surface, and an inclined side surface that is disposed so as to be continuous with an upper end of the inner side surface as one of the pair of inner side surfaces and is inclined at an upper part thereof toward the inner side surface as the other of the pair of inner side surfaces. The expansion/contraction part as at least one of expansion/contraction parts is at least partly disposed along the inclined side surface.

### RELATED APPLICATIONS

This application is based upon and claims the benefit of priority from the corresponding Japanese Patent Application No. 2019-121105 (filed on Jun. 28, 2019), the contents of which are incorporated herein by reference.

### BACKGROUND OF THE INVENTION

### Field of the Invention

The present invention relates to a chair-type massage machine including an arm treatment portion.

### Description of Related Art

The publication of Japanese Patent No. 6475297 discloses a chair-type massage machine including an armrest portion. The armrest portion is provided inside with expansion/contraction bags. The expansion/contraction bags act to expand and contract, thereby massaging (treating) each of forearms or the like of a person to be treated, which is placed in an interior of the armrest portion.

The chair-type massage machine described in the publication of Japanese Patent No. 6475297 is configured so that each of the forearms or the like of the person to be treated is inserted through an opening provided at an upper part of the armrest portion and thus has difficulty in treating, from above, the each of the forearms or the like of the person to be treated. Furthermore, the expansion/contraction bags are disposed on an inner side surface of the armrest portion and thus might interfere with the each of the forearms or the like being inserted or pulled out through the opening.

### SUMMARY OF THE INVENTION

With the above in view, it is an object of the present invention to provide a chair-type massage machine including an arm treatment portion that treats an arm or the like, the arm treatment portion being configured so that the arm or the like is easily inserted thereinto or pulled out therefrom, the chair-type massage machine being capable of effectively treating the arm or the like.

In order to achieve the above-described object, a chair-type massage machine according to the present invention includes an arm treatment portion that treats an arm. The arm treatment portion includes an arm housing concave part that is capable of housing the arm therein and is open at an upper part thereof and one or a plurality of expansion/contraction parts that are disposed in the arm housing concave part and are capable of alternately expanding or contracting by use of air. The arm housing concave part includes a placement surface on which the arm is placed, a pair of inner side surfaces that are disposed on an upper side of the placement surface and face each other around the arm placed on the placement surface, and an inclined side surface that is disposed so as to be continuous with an upper end of one of the pair of inner side surfaces and is inclined toward the other of the pair of inner side surfaces along an upward direction. At least one of the expansion/contraction parts is at least partly disposed along the inclined side surface.

### BRIEF DESCRIPTION OF THE DRAWINGS

FIG. 1 is a perspective view of a chair-type massage machine according to the present invention.

FIG. 2 is a perspective view of an arm treatment portion.

FIG. 3 is a sectional view of the arm treatment portion shown in FIG. 2.

FIG. 4 is a sectional view of the arm treatment portion in a state where expansion/contraction parts have contracted.

FIG. 5 is a sectional view of an arm treatment portion as a first modification example.

FIG. 6 is a sectional view of an arm treatment portion as a second modification example.

FIG. 7 is a sectional view of an arm treatment portion as a third modification example.

FIG. 8 is a sectional view of an arm treatment portion as a fourth modification example.

### DESCRIPTION OF THE PREFERRED EMBODIMENTS

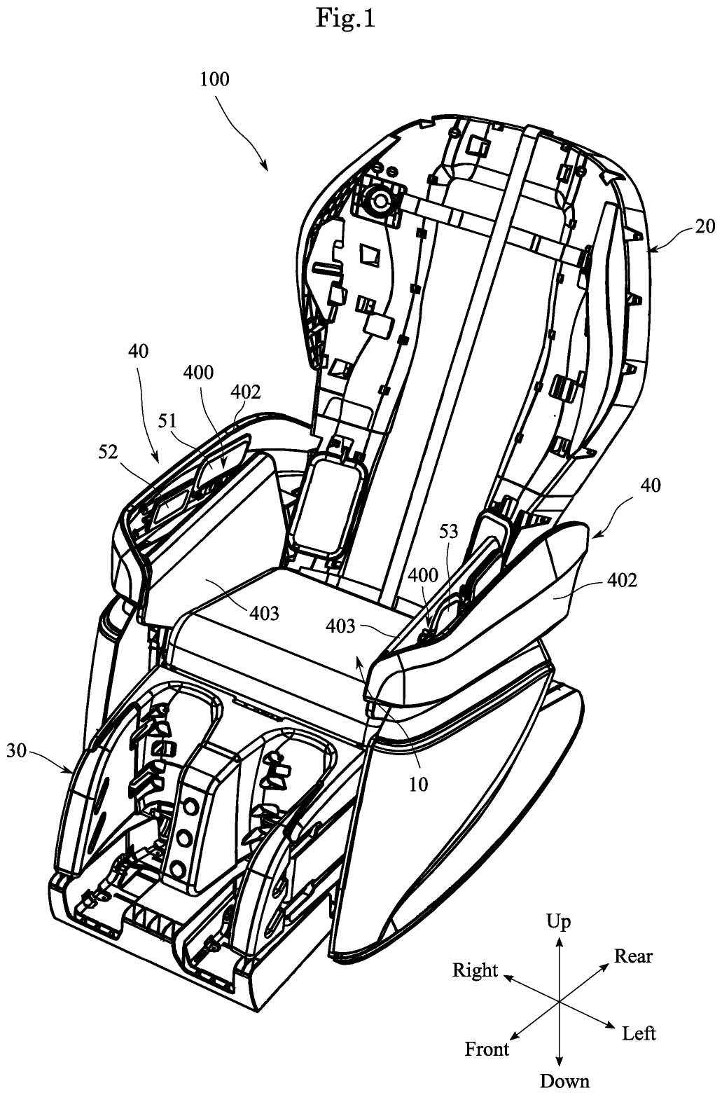

With reference to the appended drawings, the following describes an embodiment of the present invention. FIG. 1 is a perspective view of a chair-type massage machine 100 according to the present invention. In the following description, in explaining positions and orientations of the chair-type massage machine 100 and constituent members thereof, terms “front,” “rear,” “left,” “right,” “up/upper,” and “down/lower” may be used with reference to the chair-type massage machine 100 shown in FIG. 1. To be more specific, directions referred to by these terms correspond to those as viewed from a person to be treated being seated on the chair-type massage machine 100.

### <Chair-Type Massage Machine 100>

The chair-type massage machine 100 provides a massage (hereinafter, referred to as “treatment”) to an entire body of a person to be treated seated thereon. As shown in FIG. 1, the chair-type massage machine 100 includes a seat portion 10, a backrest portion 20, a leg and foot treatment portion 30, and an arm treatment portion 40. An unshown cover is attached to the chair-type massage machine 100.

The seat portion 10 is a portion on which the person to be treated is to be seated. The seat portion 10 may be provided with expansion/contraction parts that treat buttocks or thighs. The expansion/contraction parts each include, for example, a bag body (a so-called air bag) that is capable of alternately expanding or contracting by being filled with air and discharging the air therefrom. In the following description, any expansion/contraction part used has a configuration similar to this. The backrest portion 20 is disposed on a rear side of the seat portion 10 and is provided to stand upward from the seat portion 10. The backrest portion 20 has such a function that a top part thereof is inclinable rearward relative to the seat portion 10, namely, a reclining function.

The backrest portion 20 includes a massage mechanism (not shown) that, while moving in a longitudinal direction, treats a back of the person to be treated. Furthermore, the backrest portion 20 may be provided with expansion/contraction parts that treat shoulders and side parts of upper arms of the person to be treated being supported by the backrest portion 20.

The leg and foot treatment portion 30 is disposed on a front side of the seat portion 10 and is provided so as to be suspended downward from the seat portion 10. The leg and foot treatment portion 30 is configured so that a lower-end-side part thereof is pivotable about an upper end of the leg and foot treatment portion 30 as a fulcrum. The leg and foot treatment portion 30 has groove parts into which both left and right calves and feet can be inserted. The groove parts include, in interiors thereof, expansion and contraction parts that treat the calves and feet. Furthermore, there may be provided treatment parts (not shown) that rotate while being in contact with soles, thereby treating the soles. The leg and foot treatment portion 30 may be configured so that the lower-end-side part of the leg and foot treatment portion 30 pivots upward in synchronization with the reclining function of the backrest portion 20.

### <Arm Treatment Portion 40>

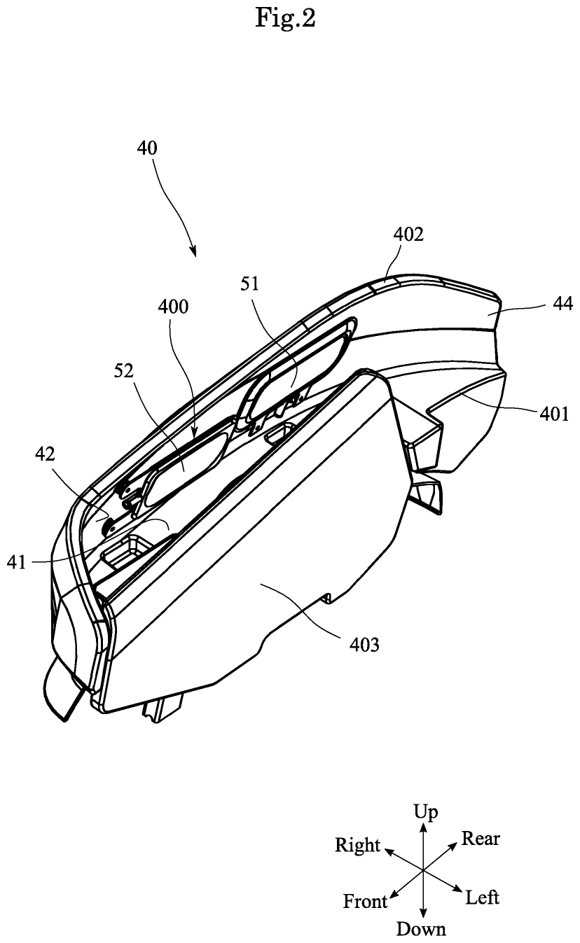

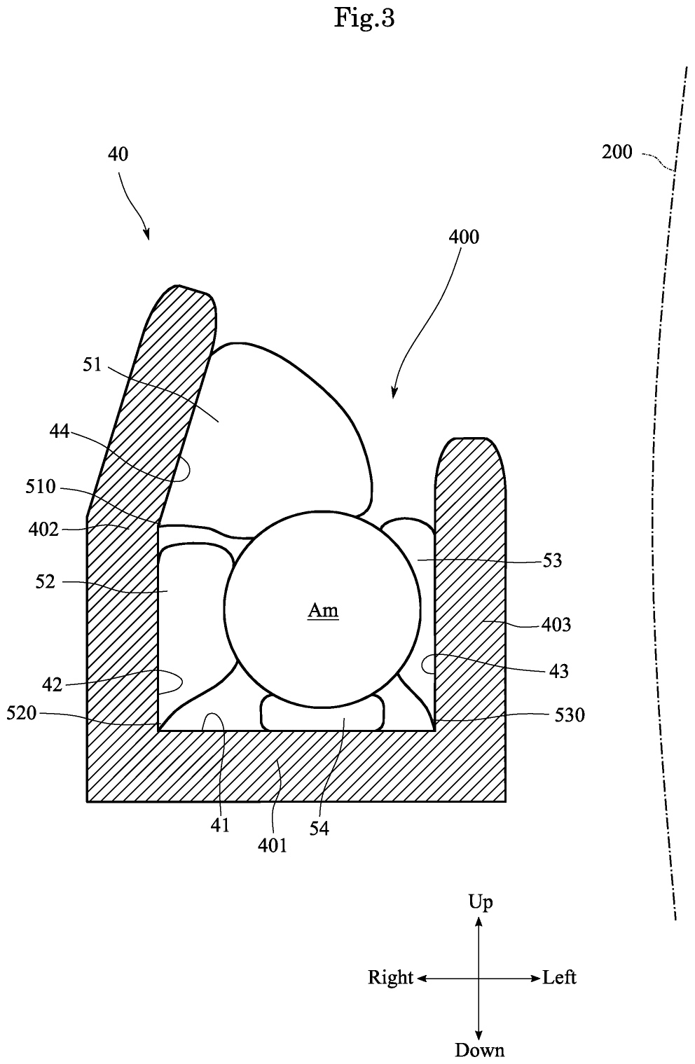

The arm treatment portion 40 treats each of arms of a person to be treated when the person to be treated is seated on the seat portion 10. A pair of arm treatment portions 40 are disposed on the left and right of the seat portion 10 in order to treat the left and right arms, respectively. The left and right arm treatment portions 40 are the same in configuration except that they are mirror-reversed from each other. Therefore, a description is made with reference to the right arm treatment portion 40 as a representative of the pair of arm treatment portions 40. FIG. 2 is a perspective view of the arm treatment portion 40. FIG. 3 is a sectional view of the arm treatment portion 40 shown in FIG. 2. In FIG. 3, a person to be treated 200 being seated on the seat portion 10 is indicated by a dashed line. In each of the drawings used in the following description, an arm Am is shown to have a circular shape for the sake of convenience, which may be different from an actual shape of the arm Am. Furthermore, in the arm treatment portion 40, expansion/contraction parts expand to press the arm Am, and each of the expansion/contraction parts at this time is also shown to have such a shape as to correspond to the circular arm Am, which may be different from an actual shape of the each of the expansion/contraction parts.

As shown in FIG. 2 and FIG. 3, the arm treatment portion 40 includes a bottom plate part 401 and a pair of side plate parts 402 and 403. The bottom plate part 401 has a substantially horizontal upper surface. The pair of side plate parts 402 and 403 are provided to stand at both end parts of the bottom plate part 401 in a left-right direction thereof. When viewed from the person to be treated 200 being seated, the side plate part 402 is disposed on an outer side with respect to the side plate part 403.

The bottom plate part 401 has a length sufficient for each of arms, namely, a forearm, a wrist, and a thumb and fingers, of the person to be treated 200 to be placed thereon. A longitudinal direction of the bottom plate part 401 is a direction along a front-rear direction of the chair-type massage machine 100. Furthermore, the side plate parts 402 and 403 extend in the front-rear direction along the bottom plate part 401, and a front end of the side plate part 402 is bent along a front end of the bottom plate part 401 so as to be in contact with a front end of the side plate part 403. An area surrounded by the bottom plate part 401 and the pair of side plate parts 402 and 403 has a groove shape with an opening provided at an upper part thereof, constituting an arm insertion groove part 400 that houses therein the arm Am of the person to be treated 200 being seated.

The arm treatment portion 40 includes the arm insertion groove part 400 and four expansion/contraction parts 51, 52, 53, and 54. In the following description, the four expansion/contraction parts 51, 52, 53, and 54 may be referred to as a first expansion/contraction part 51, a second expansion/contraction part 52, a third expansion/contraction part 53, and a fourth expansion/contraction part 54. As shown in FIG. 3, the arm insertion groove part 400 includes a placement surface 41, a pair of inner side surfaces 42 and 43, and an inclined side surface 44.

The placement surface 41 is an upper surface of the bottom plate part 401, and the arm Am housed in the arm insertion groove part 400 is placed thereon. The placement surface 41 is substantially horizontal. The inner side surface 42 is a surface of the side plate part 402 on a side closer to the person to be treated 200. The inner side surface 42 is continuous with an outer part of the placement surface 41 and extends upward from the placement surface 41. Furthermore, the inner side surface 43 is a surface of the side plate part 403 on an opposite side to the person to be treated 200. The inner side surface 43 is continuous with an inner part of the placement surface 41 and extends upward from the placement surface 41. As shown in FIG. 3, the inner side surface 42 and the inner side surface 43 are disposed to be opposed to each other via the placement surface 41.

The inclined side surface 44 is disposed so as to be continuous with an upper part of the inner side surface 42 and extends upward from the inner side surface 42. The inclined side surface 44 is inclined toward the person to be treated 200 along an upward direction. That is, the arm insertion groove part 400 includes the placement surface 41 on which the arm Am is placed, the pair of inner side surfaces 42 and 43 that are disposed to face each other around the arm Am placed on the placement surface 41, and the inclined side surface 44 that is disposed so as to be continuous with an upper end of the inner side surface 42 as one of the pair of inner side surfaces 42 and 43 and extends toward the inner side surface 43 as the other of the pair of inner side surfaces 42 and 43 along the upward direction.

As shown in FIG. 3, an upper end part of the inclined side surface 44 is positioned on an outer side with respect to the inner side surface 43. Accordingly, the arm insertion groove part 400 has a groove shape that is open upward.

The first expansion/contraction part 51 is disposed along the inclined side surface 44. The first expansion/contraction part 51 may be fixed entirely to the inclined side surface 44 or may be fixed partly thereto. In the arm treatment portion 40 shown in FIG. 3, the first expansion/contraction part 51 is fixed at a lower end part 510 thereof to the inclined side surface 44. Fixing the lower end part 510 facilitates deformation of an upper part of the first expansion/contraction part 51. As a result, it is possible to obtain an increased pressure for treating the arm Am, thus enhancing a treatment effect. There is, however, no limitation to this configuration. For example, the first expansion/contraction part 51 may be fixed at a plurality of locations thereon such as, for example, a lower end, a center, and an upper end thereof to the inclined side surface 44. Furthermore, the first expansion/contraction part 51 may include a base member (having, for example, a plate shape) that holds an expanding/contracting bag body and is fixed to the inclined side surface 44. The second expansion/contraction part 52, the third expansion/contraction part 53, and the fourth expansion/contraction part 54 may also have this configuration including the base member.

The first expansion/contraction part 51 expands by being supplied with compressed air from an unshown air compressor and contracts by discharging the compressed air. That is, the first expansion/contraction part 51 is capable of alternately expanding or contracting by use of air. When expanding, the first expansion/contraction part 51 makes contact with the inclined side surface 44 and receives a reactive force from the inclined side surface 44. Consequently, the first expansion/contraction part 51 expands downward. Thus, when expanding, the first expansion/contraction part 51 massages (treats) an upper part of the arm Am housed in the arm insertion groove part 400.

The second expansion/contraction part 52 is disposed along the inner side surface 42. The second expansion/contraction part 52 may be fixed entirely to the inner side surface 42 or may be fixed partly thereto. In the arm treatment portion 40 shown in FIG. 3, the second expansion/contraction part 52 is fixed at a lower end part 520 thereof to a part of the inner side surface 42 intersecting with the placement surface 41. There is, however, no limitation thereto, and the second expansion/contraction part 52 may be fixed at a plurality of locations thereon such as, for example, a lower end, a center, and an upper end thereof to the inner side surface 42. Similarly to the first expansion/contraction part 51, the second expansion/contraction part 52 alternately expands or contracts by taking compressed air therein and taking the compressed air out therefrom. When expanding, the second expansion/contraction part 52 makes contact with the inner side surface 42 and receives a reactive force from the inner side surface 42. Consequently, when expanding, the second expansion/contraction part 52 massages (treats) an outer side of the arm Am housed in the arm insertion groove part 400.

The third expansion/contraction part 53 is disposed along the inner side surface 43. The third expansion/contraction part 53 may be fixed entirely to the inner side surface 43 or may be fixed partly thereto. In the arm treatment portion 40 shown in FIG. 3, the third expansion/contraction part 53 is fixed at a lower end part 530 thereof to a part of the inner side surface 43 intersecting with the placement surface 41. There is, however, no limitation thereto, and the third expansion/contraction part 53 may be fixed at a plurality of locations thereon such as, for example, a lower end, a center, and an upper end thereof to the inner side surface 43. Similarly to the second expansion/contraction part 52, the third expansion/contraction part 53 alternately expands or contracts by taking compressed air therein and taking the compressed air out therefrom. When expanding, the third expansion/contraction part 53 makes contact with the inner side surface 43 and receives a reactive force from the inner side surface 43. Consequently, when expanding, the third expansion/contraction part 53 massages (treats) an inner side of the arm Am housed in the arm insertion groove part 400.

The fourth expansion/contraction part 54 is disposed along the placement surface 41. The fourth expansion/contraction part 54 may be fixed entirely to the placement surface 41 or may be fixed partly thereto. Similarly to the first expansion/contraction part 51, the fourth expansion/contraction part 54 alternately expands or contracts by taking compressed air therein and taking the compressed air out therefrom. When expanding, the fourth expansion/contraction part 54 makes contact with the placement surface 41 and receives a reactive force from the placement surface 41. Consequently, when expanding, the fourth expansion/contraction part 54 massages (treats) a lower side of the arm Am housed in the arm insertion groove part 400.

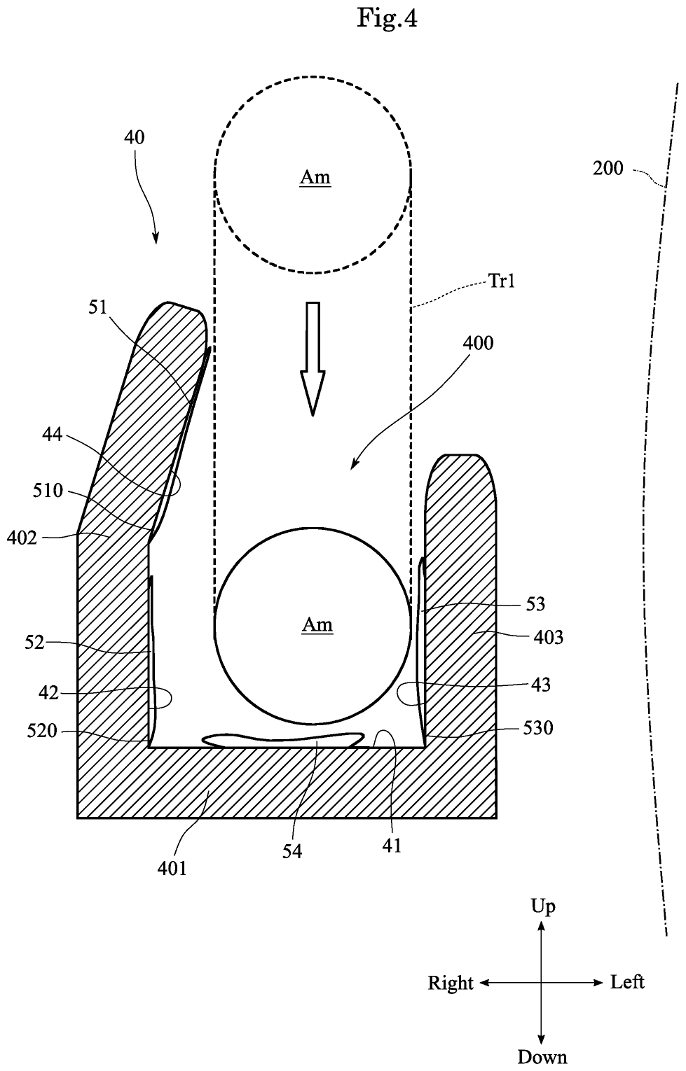

The chair-type massage machine 100 according to the present invention has the above-described configuration. Next, with reference to the appended drawings, a description is given of an operation of the arm treatment portion 40. FIG. 4 is a sectional view of the arm treatment portion 40 in a state where the expansion/contraction parts 51 to 54 have contracted.

When not providing treatment, the chair-type massage machine 100 is in a state where the first expansion/contraction part 51, the second expansion/contraction part 52, the third expansion/contraction part 53, and the fourth expansion/contraction part 54 have been deflated and thus have contracted (see FIG. 4). At this time, the first expansion/contraction part 51 contracts along the inclined side surface 44. Similarly, the second expansion/contraction part 52 contracts along the inner side surface 42, the third expansion/contraction part 53 contracts along the inner side surface 43, and the fourth expansion/contraction part 54 contracts along the placement surface 41. Thus, an interior space in the arm insertion groove part 400 is widened.

When the person to be treated 200 places the arm Am in the arm insertion groove part 400, the arm Am is inserted into the arm insertion groove part 400 through an opening provided at an upper part thereof. Similarly, after treatment of the arm Am has been ended, the arm Am is pulled outside from the arm insertion groove part 400 through the opening provided at the upper part thereof. That is, the arm Am is inserted into or pulled out from the arm insertion groove part 400 across the opening formed at the upper part of the arm insertion groove part 400.

FIG. 4 shows a trajectory Tr1 along which the arm Am is housed in an interior of the arm insertion groove part 400. As shown in FIG. 4, the trajectory Tr1 extends in a vertical up-down direction. The first expansion/contraction part 51 contracts along the inclined side surface 44, and the third expansion/contraction part 53 contracts along the inner side surface 43. Consequently, even in a case where the arm Am is inserted into or pulled out from the arm insertion groove part 400 in the vertical up-down direction, the first expansion/contraction part 51 and the third expansion/contraction part 53 are unlikely to overlap with the trajectory Tr1, thus being unlikely to cause interference. That is, in the chair-type massage machine 100, the arm Am can be easily inserted into or pulled out from the arm insertion groove part 400 in the vertical up-down direction. Furthermore, even in a case where the arm Am is displaced sideways within the arm insertion groove part 400, the first expansion/contraction part 51 and the third expansion/contraction part 53 are unlikely to cause interference, and thus the arm Am is easily inserted into or pulled out from the arm insertion groove part 400.

In the arm treatment portion 40, in a state where the arm Am is inserted into the arm insertion groove part 400, the first expansion/contraction part 51, the second expansion/contraction part 52, the third expansion/contraction part 53, and the fourth expansion/contraction part 54 are caused to alternately expand or contract, thereby massaging (treating) the upper and lower sides and the inner and outer sides of the arm Am. At this time, the first expansion/contraction part 51, the second expansion/contraction part 52, the third expansion/contraction part 53, and the fourth expansion/contraction part 54 may be caused to expand and contract at the same time or may be caused to expand and contract in a preset order. As described above, the arm treatment portion 40 includes the first expansion/contraction part 51 disposed along the inclined side surface 44, and thus the arm Am can be inserted in the up-down direction and can also be pressed from above.

The chair-type massage machine 100 includes the arm treatment portion 40. Thus, the arm Am can be easily inserted into or pulled out from the arm insertion groove part 400 by being moved in a vertical direction to the arm insertion groove part 400 through the opening provided at the upper part thereof, and the arm Am can also be treated from above. Consequently, upon being seated, the person to be treated 200 can easily place the arm Am in the arm treatment portion 40. This provides increased convenience to the person to be treated 200. Furthermore, the arm Am can be massaged (treated) from an upper part of the arm treatment portion 40 at which the opening is formed, and thus a treatment effect can be enhanced.

Note that, this embodiment includes, in addition to the first expansion/contraction part 51, the second expansion/contraction part 52, the third expansion/contraction part 53, and the fourth expansion/contraction part 54. There is, however, no limitation thereto. In a case where a sufficient massaging effect can be provided by expansion of the first expansion/contraction part 51, the second expansion/contraction part 52, the third expansion/contraction part 53, and the fourth expansion/contraction part 54 may be omitted. Also, in order to enhance a massaging effect, only one or some of the expansion/contraction parts 51 to 54 may be omitted. In this case, at least one of the inner side surfaces 42 and 43 and the placement surface 41 may have such a shape as to enhance the massaging effect, such as an inwardly expanding shape or a bellows shape.

### First Modification Example

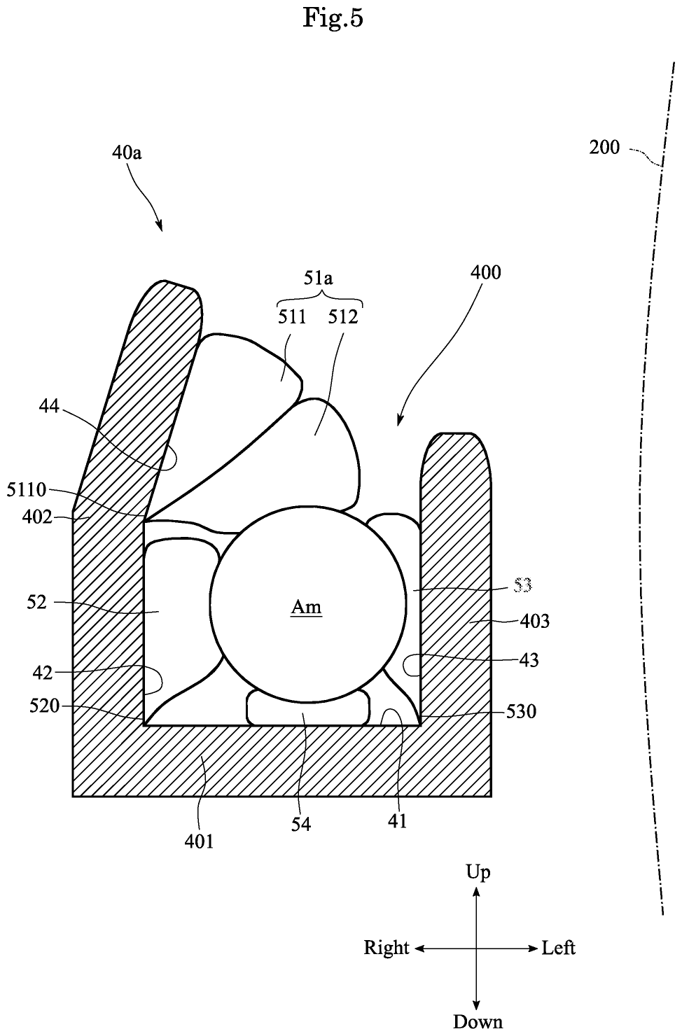

With reference to the appended drawings, a description is given of a modification example of the arm treatment portion of the chair-type massage machine according to the present invention. FIG. 5 is a sectional view of an arm treatment portion 40a as a first modification example. In the arm treatment portion 40a shown in FIG. 5, there is provided a first expansion/contraction part 51a that is different from the first expansion/contraction part 51 of the arm treatment portion 40. Other parts of the arm treatment portion 40a have the same configurations as those of the various parts of the arm treatment portion 40. Therefore, the parts of the arm treatment portion 40a that are substantially the same as those of the arm treatment portion 40 are denoted by the same reference characters, and detailed descriptions thereof are omitted.

As shown in FIG. 5, the first expansion/contraction part 51a of the arm treatment portion 40a includes a side surface contacting bag 511 and an arm contacting bag 512. The side surface contacting bag 511 and the arm contacting bag 512 are bag bodies that are capable of alternately expanding or contracting by use of air. The side surface contacting bag 511 is disposed along the inclined side surface 44 and is fixed at least at a lower end part 5110 thereof to the inclined side surface 44. The arm contacting bag 512 is fixed to the side surface contacting bag 511. When the side surface contacting bag 511 and the arm contacting bag 512 expand, the arm contacting bag 512 makes contact with an upper surface of the arm Am. At this time, the side surface contacting bag 511 receives a reactive force from the inclined side surface 44, and thus an upper surface of the arm Am is treated.

As in the first expansion/contraction part 51a, two expansion/contraction parts are disposed to be overlaid on each other in an expansion direction, and thus the two expansion/contraction parts as a whole can be caused to expand more largely than in a case of using a single expansion/contraction part. Thus, an increased force can be used to treat the upper surface of the arm Am.

Though not shown, when the side surface contacting bag 511 and the arm contacting bag 512 have contracted, the side surface contacting bag 511 and the arm contacting bag 512 are disposed along the inclined side surface 44. Furthermore, a deformation amount of each of the side surface contacting bag 511 and the arm contacting bag 512 is small, and thus when the side surface contacting bag 511 and the arm contacting bag 512 have contracted along the inclined side surface 44 in a state of being overlaid on each other, as viewed from above, they are hidden below the inclined side surface 44. Consequently, the side surface contacting bag 511 and the arm contacting bag 512 are unlikely to interfere with the arm Am being inserted into or pulled out from the arm insertion groove part 400, and thus the arm Am is easily inserted thereinto or pulled out therefrom.

While in this modification example, the first expansion/contraction part 51a has a configuration in which the two bag bodies are overlaid on each other, three or more bag bodies may be disposed to be overlaid on each other. Furthermore, the bag bodies may be partly overlaid on each other. Moreover, while this modification example discloses the first expansion/contraction part 51a having a configuration in which a plurality of bag bodies are overlaid on each other, there is no limitation thereto, and at least one of the second expansion/contraction part 52, the third expansion/contraction part 53, and the fourth expansion/contraction part 54 may also have a configuration similar thereto.

### Second Modification Example

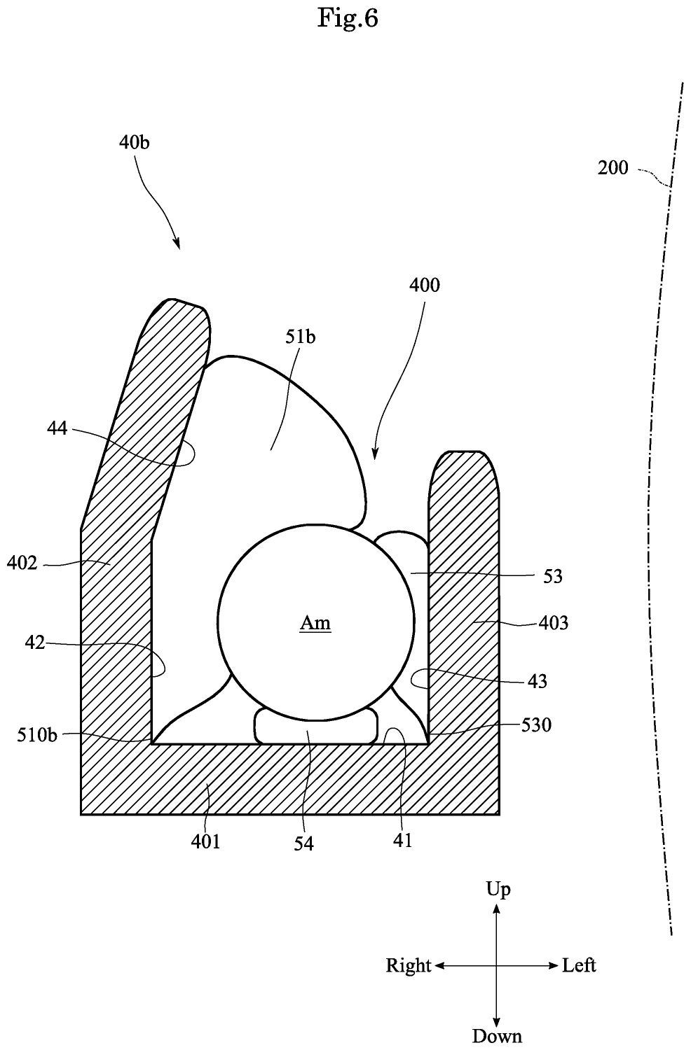

With reference to the appended drawings, a description is given of another modification example of the arm treatment portion of the chair-type massage machine according to the present invention. FIG. 6 is a sectional view of an arm treatment portion 40b as a second modification example. In the arm treatment portion 40b shown in FIG. 6, there is provided a first expansion/contraction part 51b that is different from the first expansion/contraction part 51 of the arm treatment portion 40, and the second expansion/contraction part 52 is omitted. Other parts of the arm treatment portion 40b have the same configurations as those of the various parts of the arm treatment portion 40. Therefore, the parts of the arm treatment portion 40b that are substantially the same as those of the arm treatment portion 40 are denoted by the same reference characters, and detailed descriptions thereof are omitted.

As shown in FIG. 6, the first expansion/contraction part 51b of the arm treatment portion 40b is disposed along and across both of the inclined side surface 44 and the inner side surface 42. In the arm treatment portion 40b, the first expansion/contraction part 51b is fixed at a lower end part 510b thereof to a part of the inner side surface 42 intersecting with the placement surface 41.

When the first expansion/contraction part 51b has expanded, the first expansion/contraction part 51b presses the arm Am from the outer side and upper side of the arm Am to treat the arm Am. The first expansion/contraction part 51b is structured so that an upper part thereof in the up-down direction is more likely to expand than a lower part thereof in the up-down direction. Thus, a substantially equal pressure can be applied to treat the outer side of the arm Am close to the inner side surface 42 and the upper side of the arm Am far from the inclined side surface 44.

In the arm treatment portion 40b, the first expansion/contraction part 51b is configured to serve also as the second expansion/contraction part 52. This configuration can reduce an amount of piping for supplying compressed air and thus can achieve a simplified configuration of the chair-type massage machine 100. Furthermore, the first expansion/contraction part 51b is caused to contract along the inner side surface 42 and the inclined side surface 44, thus being unlikely to interfere with the arm Am being inserted or pulled out. While the first expansion/contraction part 51b is fixed at a lower end thereof to the part of the inner side surface 42 intersecting with the placement surface 41, there is no limitation thereto, and the first expansion/contraction part 51b may be fixed so that at least part of a part thereof disposed along the inner side surface 42 is fixed to the inner side surface 42.

### Third Modification Example

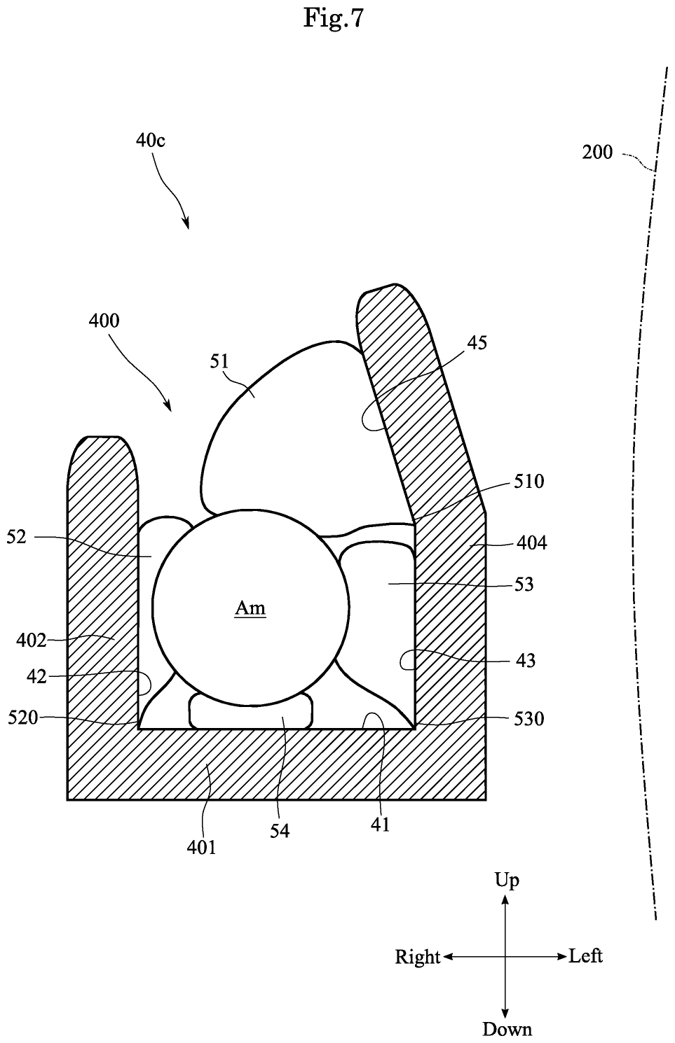

With reference to the appended drawings, a description is given of yet another modification example of the arm treatment portion of the chair-type massage machine according to the present invention. FIG. 7 is a sectional view of an arm treatment portion 40c as a third modification example. In the arm treatment portion 40c shown in FIG. 7, the inclined side surface 45 is provided at a side plate part 404 disposed on a side closer to the person to be treated 200, and the inclined side surface 45 provided at the side plate part 402 disposed on a side farther from the person to be treated 200 is omitted. That is, in the arm treatment portion 40c, the inclined side surface 45 is provided on the side closer to the person to be treated 200. Other parts of the arm treatment portion 40c have the same configurations as in the arm treatment portion 40. Therefore, the parts of the arm treatment portion 40c that are substantially the same as those of the arm treatment portion 40 are denoted by the same reference characters, and detailed descriptions thereof are omitted.

As shown in FIG. 7, in the arm treatment portion 40c, the inclined side surface 45 is provided on an inner side of the arm insertion groove part 400 and on an upper side of the side plate part 404 disposed on the side closer to the person to be treated 200. That is, the arm treatment portion 40c is open at an upper part thereof on the side farther from the person to be treated 200 (an outer side). Depending on, for example, a height of the arm treatment portion 40c relative to the seat portion 10, on the side farther from the person to be treated 200 (the outer side), the arm Am may be more easily inserted into or pulled out from the arm insertion groove part 400 by being moved in the vertical up-down direction than on the side closer to the person to be treated 200 (an inner side). By adopting a configuration similar to that of the arm treatment portion 40c, on the side farther from the person to be treated 200 (the outer side), the arm Am is more easily inserted or pulled out by being moved vertically upward. This can further increase convenience to the person to be treated 200.

### Fourth Modification Example

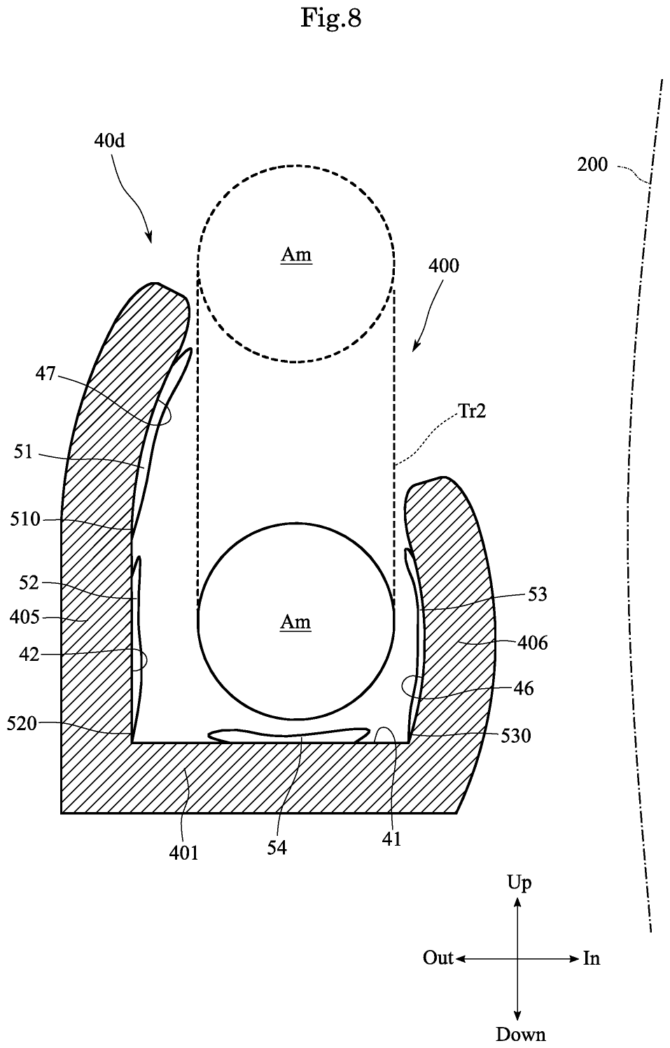

With reference to the appended drawings, a description is given of yet still another modification example of the arm treatment portion of the chair-type massage machine according to the present invention. FIG. 8 is a sectional view of an arm treatment portion 40d as a fourth modification example. In the arm treatment portion 40d shown in FIG. 8, there are provided side plate parts 405 and 406 that are different from the side plate parts 402 and 403 of the arm treatment portion 40, respectively. Other parts of the arm treatment portion 40d have the same configurations as in the arm treatment portion 40. Therefore, the parts of the arm treatment portion 40d that are substantially the same as those of the arm treatment portion 40 are denoted by the same reference characters, and detailed descriptions thereof are omitted.

As shown in FIG. 8, the side plate part 405 of the arm treatment portion 40d farther from the person to be treated 200 extends vertically upward from an end part of the bottom plate part 401 on a side farther from the person to be treated 200 and is bent at an upper part thereof toward the side plate part 406 along the upward direction. Thus, a surface of the side plate part 405 on an inner side of the arm insertion groove part 400 includes the inner side surface 42 that extends vertically upward from the placement surface 41 and an inclined side surface 47 that is joined to an upper end of the inner side surface 42 and extends toward the side plate part 406 along the upward direction. That is, the inclined side surface 47 is bent outward at an intermediate part thereof in the up-down direction as viewed from the interior of the arm insertion groove part 400.

Furthermore, the side plate part 406 of the arm treatment portion 40d closer to the person to be treated 200 extends upward from an end part of the bottom plate part 401 on a side closer to the person to be treated 200. Further, the side plate part 406 is bent to bulge outward at an intermediate part thereof in the up-down direction as viewed from the interior of the arm insertion groove part 400. Thus, an inner side surface 46 of the side plate part 406 on the inner side of the arm insertion groove part 400 is bent outward at an intermediate part thereof in the up-down direction as viewed from the interior of the arm insertion groove part 400.

In the arm insertion groove part 400 of the arm treatment portion 40d, the inclined side surface 47 and the inner side surface 46 are concave outward. Consequently, when the first expansion/contraction part 51 attached to the inclined side surface 47 has contracted, the first expansion/contraction part 51 is housed in a concave part of the inclined side surface 47. Similarly, when the third expansion/contraction part 53 attached to the inner side surface 46 has contracted, the third expansion/contraction part 53 is housed in a concave part of the inner side surface 46.

The first expansion/contraction part 51 and the third expansion/contraction part 53 are unlikely to overlap with a trajectory Tr2 of the arm Am along which the arm Am is inserted into or pulled out from the arm insertion groove part 400 through the opening provided at the upper part thereof by being moved in the vertical up-down direction. Consequently, when the arm Am is inserted into or pulled out from the arm insertion groove part 400 by being moved in the vertical up-down direction, the first expansion/contraction part 51 and the third expansion/contraction part 53 are unlikely to cause interference, and thus the arm Am is more easily inserted into or pulled out from the arm insertion groove part 400. This provides further increased convenience to the person to be treated 200.

While in this example, the inner side surface 42 has a flat surface shape, there is no limitation thereto, and the inner side surface 42 may be bent in a similar manner to the inclined side surface 47. In this case, the inner side surface 42 may have a curvature equal to or different from that of the inclined side surface 47. Furthermore, the placement surface 41 may also be bent in the similar manner.

While each of the above-described arm treatment portions 40 and 40a to 40d is configured to include the arm insertion groove part 400 whose lower surface and left and right end surfaces are surrounded by three plate parts, there is no limitation thereto. For example, a similar configuration can be obtained by forming a groove part on an upper surface of each of armrest portions of a chair, on which a person to be treated places each of his/her elbows when seated on the chair, each of arms of the person to be treated being insertable into the groove part. In this case, an inclined side surface may be formed by forming the upper surface of the each of armrest portions so that the upper surface is varied in level, or a side plate part having an inclined side surface may be formed so as to protrude upward from the upper surface of the each of armrest portions.

Furthermore, in each of the above-described arm treatment portions 40 and 40a to 40d, the pair of inner side surfaces 42 and 43 or 46 are each disposed so as to be continuous with the placement surface 41. There is, however, no limitation thereto, and a configuration may be adopted in which at least one of the pair of inner side surfaces 42 and 43 or 46 is not continuous with the placement surface 41. For example, a configuration may be adopted in which the pair of inner side surfaces 42 and 43 or 46 and the placement surface 41 are formed as separate members from each other, and a gap is formed between each of the pair of inner side surfaces 42 and 43 or 46 and the placement surface 41.

While the foregoing has described the embodiment of the present invention, the present invention is not limited thereto. Furthermore, the embodiment of the present invention can be implemented by adding various modifications thereto without departing from the spirit of the invention.

The foregoing chair-type massage machine 100 according to the present invention includes the arm treatment portion 40 that treats the arm Am. The arm treatment portion 40 includes the arm insertion groove part 400 that is capable of housing the arm Am therein and is open at an upper part thereof and one or a plurality of expansion/contraction parts 51 to 54 that are disposed in the arm insertion groove part 400 and are capable of alternately expanding or contracting by use of air. The arm insertion groove part 400 includes the placement surface 41 on which the arm Am is placed, the pair of inner side surfaces 42 and 43 that are disposed on an upper side of the placement surface 41 and face each other around the arm Am placed on the placement surface 41, and the inclined side surface 44 that is disposed so as to be continuous with an upper end of the inner side surface 42 as one of the pair of inner side surfaces 42 and 43 and is inclined toward the inner side surface 43 as the other of the pair of inner side surfaces 42 and 43 along the upward direction. The expansion/contraction part 51 as at least one of the expansion/contraction parts 51 to 54 is at least partly disposed along the inclined side surface 44.

In the above-described chair-type massage machine 100, the expansion/contraction part 51a may be formed by overlaying on each other the plurality of bag bodies 511 and 512 that are capable of alternately expanding or contracting by use of air.

In the above-described chair-type massage machine 100, the expansion/contraction part 51b disposed along the inclined side surface 44 is disposed also along the inner side surface 42 as one of the pair of inner side surfaces 42 and 43. A part of the expansion/contraction part 51b, which is disposed along the inclined side surface 44, may be configured to expand more largely than a part of the expansion/contraction part 51b, which is disposed along the inner side surface 42.

In the above-described chair-type massage machine 100, the expansion/contraction part 52 as at least one of the expansion/contraction parts 52 to 54 may be at least partly disposed along the inner side surface 42 as one of the pair of inner side surfaces 42 and 43.

In the above-described chair-type massage machine 100, the expansion/contraction part 53 as at least one of the expansion/contraction parts 52 to 54 may be at least partly disposed along the inner side surface 43 as the other of the pair of inner side surfaces 42 and 43.

In the above-described chair-type massage machine 100, the expansion/contraction part 54 as at least one of the expansion/contraction parts 52 to 54 may be at least partly disposed along the placement surface 41.

In the above-described chair-type massage machine 100, the expansion/contraction part 51b may be fixed at least at a lower end part thereof to the arm insertion groove part 400.

In the above-described chair-type massage machine 100, the inner side surface 46 as the other of the pair of inner side surfaces 42 and 46 may bulge outward at an intermediate part thereof in the up-down direction as viewed from the arm insertion groove part 400.

The present invention is applicable to a chair-type massage machine that provides a massage to a body of a person to be treated.

What is claimed is:

1. A chair-type massage machine comprising an arm treatment portion that treats an arm,
wherein
the arm treatment portion includes:
an arm insertion groove part that is capable of housing the arm therein and is open at an upper part thereof; and
one or a plurality of expansion/contraction parts that are disposed in the arm insertion groove part and are capable of alternately expanding or contracting by use of air,
the arm insertion groove part includes:
a placement surface on which the arm is placed;
a pair of inner side surfaces that are disposed on an upper side of the placement surface and face each other around the arm placed on the placement surface; and
an inclined side surface that is disposed so as to be continuous with an upper end of one of the pair of inner side surfaces and is inclined toward the other of the pair of inner side surfaces along an upward direction, and
at least one of the expansion/contraction parts is at least partly disposed along the inclined side surface.

2. The chair-type massage machine according to claim 1, wherein
at least one of the expansion/contraction parts is formed by overlaying on each other a plurality of bag bodies that are capable of alternately expanding or contracting by use of air.

3. The chair-type massage machine according to claim 1, wherein
the at least one of the expansion/contraction parts disposed along the inclined side surface is disposed also along the one of the pair of inner side surfaces, and
a part of the at least one of the expansion/contraction parts, which is disposed along the inclined side surface, is configured to expand more largely than a part of the at least one of the expansion/contraction parts, which is disposed along the one of the pair of inner side surfaces.

4. The chair-type massage machine according to claim 1, wherein
at least one of the expansion/contraction parts is at least partly disposed along the one of the pair of inner side surfaces.

5. The chair-type massage machine according to claim 1, wherein
at least one of the expansion/contraction parts is at least partly disposed along the other of the pair of inner side surfaces.

6. The chair-type massage machine according to claim 1, wherein
at least one of the expansion/contraction parts is at least partly disposed along the placement surface.

7. The chair-type massage machine according to claim 1, wherein
at least one of the expansion/contraction parts is fixed at least at a lower end part thereof to the arm insertion groove part.

8. The chair-type massage machine according to claim 1, wherein
the other of the pair of inner side surfaces bulges outward at an intermediate part thereof in an up-down direction as viewed from inside of the arm insertion groove part.
